(19) United States
(12) Patent Application Publication
(10) Pub. No.: US 2017/0055038 A1
(43) Pub. Date: Feb. 23, 2017

(54) Handheld Devices And Applications for TV

(71) Applicant: Gang Ho, Plano, TX (US)

(72) Inventor: Gang Ho, Plano, TX (US)

(21) Appl. No.: 14/934,248

(22) Filed: Nov. 6, 2015

Related U.S. Application Data
(60) Provisional application No. 62/207,026, filed on Aug. 19, 2015.

(51) Int. Cl. H04N 21/482; H04N 21/422; G06F 3/0488; G06F 3/0354; H04N 21/442; H04N 21/434; G06F 3/0346

(52) U.S. Cl. CPC H04N 21/4825; H04N 21/4345; H04N 21/42219; G06F 3/0346; G06F 3/03543; H04N 21/44222; H04N 21/42224; H04N 21/42201; G06F 3/04883

(57) ABSTRACT

Disclosed is a handheld device having motion sensing, graphics processing, and wireless communication capabilities. The handheld device is configured to detect a user command through motion, translate the user command to a TV command, and transmit the TV command wirelessly. The handheld device may further include voice recognition capability. The handheld device may be further configured to obtain and store electronic program guide (EPG).

### PRIORITY

This application claims the benefit of U.S. Prov. No. 62/207,026 entitled “Handheld Devices and Applications for TV,” filed Aug. 19, 2015, herein incorporated by reference in its entirety.

### TECHNICAL FIELD

The present disclosure generally relates to mobile or handheld devices capable of sensing motions and processing graphics. More particularly, but not by way of limitation, the present disclosure relates to a handheld device, with an application running thereon, serves as an air mouse for controlling TV and displaying graphical information on the TV.

### BACKGROUND

Currently, home TV systems generally include set-top boxes (STBs) for decoding video streams, storing electronic program guide (EPG), and performing other video-related functions. Upcoming 4K (Ultra High Definition, 3840×2160 pixels) contents and new user interfaces (UIs) require more powerful STBs. However, upgrading existing STBs or purchasing new STBs can be expensive for the end users. Another component in existing home TV systems is a remote control, which acts as a man-machine interface. A typical remote control includes many buttons, either physical buttons or virtual buttons displayed on a touch-screen. A user presses a button (e.g., up, down, play, stop, etc.) on the remote control to make a selection on the TV. With this type of remote control, a user has to look down at the remote control when making selections, which can be inconvenient sometimes, for example, when the user watches TV in a dark room.

Meanwhile, handheld devices such as smartphones (e.g., iPhone™), tablets (e.g., iPad™), and other portable devices (e.g., iTouch™) are getting more powerful. They are typically equipped with motion sensors (e.g., accelerometers, gyroscopes) and powerful graphics processors. Also, the broadband connection at home is getting faster with Wi-Fi and other technologies. Hence, it is possible and desirable to use handheld devices to enhance the existing home TV systems and user viewing experiences.

### SUMMARY

The disclosed handheld device is configured to run an air mouse application (App) thereon. With the air mouse App running, the handheld device functions as an air mouse. The air mouse may or may not have buttons or keys displayed on the handheld device. A user holds the handheld device and makes a motion or a gesture such as a twist, a tilt, a shake, a swipe, a tap, multiple quick taps, a push down (or pressing down), an up-down move, a left-right (or side-to-side) move, and other type of motions. The handheld device senses the motion, translates the motion to a command, and passes the command to a TV. In an embodiment, the command is passed to the TV through an STB.

The handheld device keeps a mapping between the TV's display screen and the handheld device's own screen, which may be an internal virtual screen or an actual display screen. If the TV's screen resolution and the handheld's screen resolution are different, a mapping between the two is used for both the X and the Y axes. In an embodiment, the mapping is linear. A symbol of the air mouse may be displayed on the TV. The air mouse's position on the handheld device and the air mouse's position on the TV are synchronized and may be updated periodically. The air mouse's position on the handheld device (and hence its position on the TV) is determined by the handheld device based on motion sensing. The position of the air mouse is passed directly to the TV, or indirectly to the TV through an STB.

The disclosed air mouse is capable of voice control. A user may make a voice command, such as “channel up,” “channel down”, “mute,” and so on. The air mouse receives a voice command, translates the voice command to a TV command, and passes the TV command to a TV. In an embodiment, the TV command is passed to the TV through an STB.

With the air mouse (the handheld device running the air mouse App), the user does not have to look at the screen of the handheld device. The user only needs to look at the TV and issues a command through motion, gesture, or voice. This greatly enhances the user's viewing experiences when watching TV. For example, when a user watches TV in a dark room, he or she may not be able to see, or simply does not want to get distracted with, the buttons on a remote control.

The disclosed handheld device is configured to run an EPG application (App) thereon, which provides an EPG function to a user. The handheld device retrieves or otherwise gets the EPG from a TV service provider, and stores it in the handheld device. The handheld device also gets the resolution of the user's TV, and adjusts the formats (e.g., sizes) of the UI of the EPG before passing it to the TV for proper display. The EPG is updated periodically from a cloud server based on the location of the handheld device. With the EPG App, the handheld device becomes a personalized portable EPG for the user. Any action to the EPG by the user is processed by the handheld device and the corresponding UI changes may be displayed on a TV. A user may use the air mouse App to navigate and select highlighted item(s) on the EPG. In an embodiment, the UI of the EPG is passed to a TV through an STB.

### BRIEF DESCRIPTION OF THE DRAWINGS

The accompanying drawings illustrate embodiments of the systems and methods disclosed herein and together with the description, serve to explain the principles of the present disclosure.

FIG. 1A is a schematic view of a system constructed according to various aspects of the present disclosure.

FIG. 1B is a schematic view of a handheld device constructed according to various aspects of the present disclosure.

FIG. 2 illustrates some motions of a handheld device, in accordance to some embodiments.

FIG. 3 is a flow chart of an air mouse application, according to some embodiments of the present disclosure.

FIG. 4 is a flow chart of an air mouse application with voice control capabilities, according to some embodiments of the present disclosure.

FIG. 5 is a flow chart of an EPG application, according to some embodiments of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one having ordinary skill in the art to which the disclosure relates. For example, the features, components, and/or steps described with respect to one embodiment may be combined with the features, components, and/or steps described with respect to other embodiments of the present disclosure to form yet another embodiment of a device, system, or method according to the present disclosure even though such a combination is not explicitly shown. Further, for the sake of simplicity, in some instances the same reference numerals are used throughout the drawings to refer to the same or like parts.

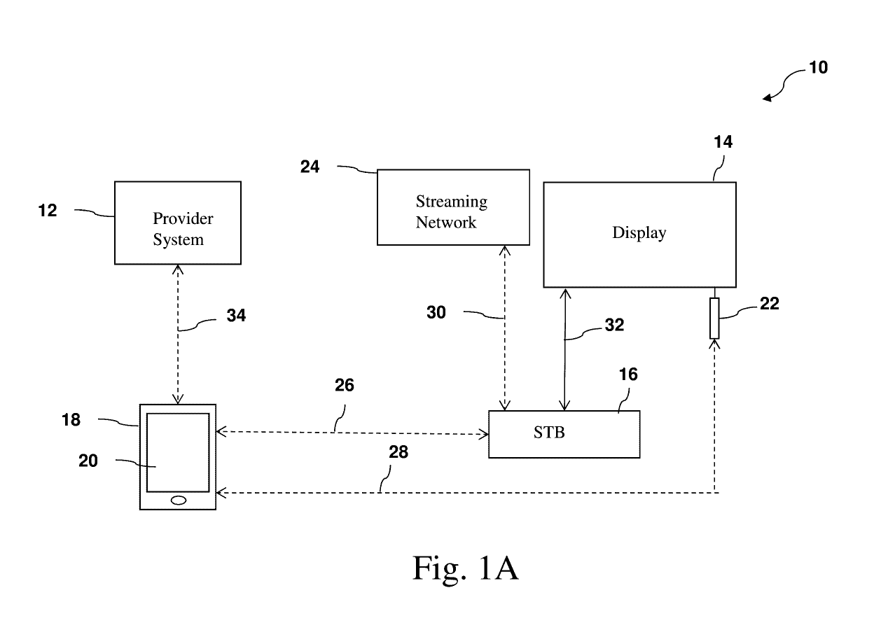

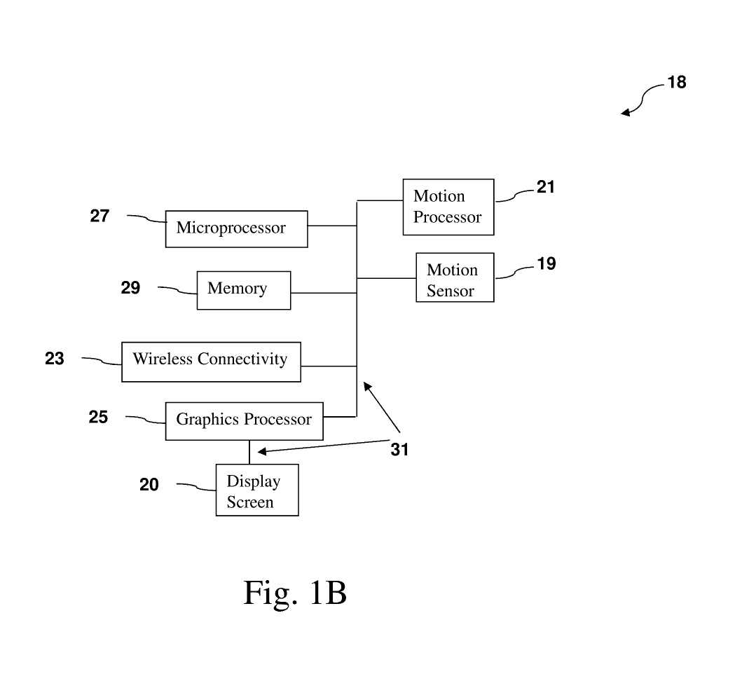

FIG. 1A is a schematic view of a system 10 constructed according to various aspects of the present disclosure. Referring to FIG. 1A, the system 10 includes a provider system 12 which may be a system deployed by a television (TV) service provider. In embodiments, the provider system 12 stores information about subscribers and various TV packages. The provider system 12 further generates and stores electronic program guides (EPG). An EPG contains current and scheduled TV programs that are or will be available on each channel and a short summary or commentary for each TV program. The system 10 further includes a display device 14. In embodiments, the display device 14 may be a TV, a smart TV, a LED display panel, a plasma display panel, or other display device. For the convenience of discussion, the display device 14 is also referred to as the TV 14 in the following discussion. The system 10 further includes a set-top box (STB) 16. The STB 16 is connected to the TV 14 through a link 32. In an embodiment, the link 32 is an HDMI cable.

The system 10 further includes a handheld device 18. In the present embodiment, the handheld device 18 includes a display screen 20. In various embodiments, the screen 20 may be a touch screen, such as a single touch or multi-touch screen. In another embodiment, the handheld device 18 does not include a display screen, but is capable of maintaining a virtual screen internally, such as in a memory, by its graphics processor. In the following discussion, unless otherwise specified, screen 20 refers to either an actual display screen, which a user may see or touch, or a virtual screen, which is not visible to a user but nonetheless exists internally in the handheld device 18. The screen 20 has a certain size and resolution, such as 4.7 inches with 750×1334 pixels, or another size and resolution.

FIG. 1B illustrates various components of the handheld device 18, according to embodiments of the present disclosure. Referring to FIG. 1B, the handheld device 18 includes a motion sensor 19 such as an accelerometer, a gyroscope, a magnetometer, or other type of motion sensors. The handheld device 18 further includes a motion processor 21 such as a standalone motion processor or a motion coprocessor, which is capable of receiving motion signals from the motion sensor 19 and processing the motion signals accordingly. The handheld device 18 further includes a wireless connectivity module 23 that is capable of wireless communication, for example, transmitting and receiving Internet Protocol (IP) packets through a Wi-Fi network. In an embodiment, the wireless connectivity module 23 is compatible with IEEE 802.11 standard, such as 802.11a, 802.11b, 802.11g, 802.11n, other 802.11 protocols, or a combination thereof. In another embodiment, the wireless connectivity module 23 uses Bluetooth technologies. Various other wireless technologies are possible for the wireless connectivity module 23. The handheld device 18 further includes a graphics processor 25 that is capable of processing graphics, such as PowerVR GX6450 from Imagination Technologies Group. The handheld device 18 further includes a microprocessor 27, such as an ARM-based central processing unit. The handheld device 18 further includes memory 29, which may comprise random access memory (RAM), read-only memory (ROM), or other type of computer-readable storage medium. The handheld device 18 may further include other components (not shown). The various components of the handheld device 18 are interconnected by one or more system buses 31. The handheld device 18 further includes software configured to run on the hardware platform. The software includes operating systems (OS) software and applications (App) software. The software may include source code or object code, and many encompass any set of instructions capable of being executed by the hardware platform of the handheld device 18. In some embodiments, the handheld device 18 has voice recognition capability such as Siri of Apple Inc.'s iOS. In various embodiments, the handheld device 18 may be a personal digital assistant (PDA) such as Apple Inc.'s iPod Touch; a smart phone such as Apple Inc.'s iPhone™, Samsung Inc.'s Galaxy, or other branded smart phones; a tablet such as Apple Inc.'s iPad; a gaming device; or other types of portable devices.

Referring back to FIG. 1A, the system 10 further includes a media player 22 that is plugged to the TV 14 and streams audio/video contents to the TV 14. In an embodiment, the media player 22 is an HDMI dongle such as the HDMI dongle from Always Innovating Company or Google Inc.'s Chromecast HDMI dongle. The system 10 further includes a streaming network 24 which may be a content delivery network (CDN). The streaming network 24 provides audio/video streams to the STB 16. The STB 16 subsequently decodes and/or decrypts the audio/video streams and sends the contents to the TV 14 in proper formats.

The provider system 12 and the handheld device 18 are connected through a link 34 which may be the Internet. The TV 14, the STB 16, and the handheld device 18 are typically located in a room such as in home or in a hotel room. The handheld device 18 and the STB 16 are connected through a link 26 which may be a Wi-Fi network where the handheld device 18 and the STB 16 have the same IP subnet. The handheld device 18 and the media player 22 are connected through a link 28 which may be a Wi-Fi network where the handheld device 18 and the media player 22 have the same IP subnet. In an embodiment, the links 26 and 28 may be in the same Wi-Fi network. The STB 16 and the streaming network 24 are connected through a link 30 which may be the Internet.

In embodiments, the handheld device 18 is configured to run one or more applications (App) thereon. An App is a computer program or software (a set of computer-executable instructions) designed to run on the handheld device 18. An App may be pre-installed on the handheld device 18 or installed through an application distribution platform, such as Apple Inc.'s App Store, Google Inc.'s Google Play, or Microsoft Windows Phone Store. An App may be stored in a storage media, such as the memory 29, of the handheld device 18. In at least one embodiment, the handheld device 18 is configured to run an air mouse App. With the air mouse App running, the handheld device 18 functions as an air mouse for the TV 14. In an embodiment, the air mouse does not display buttons or keys on the handheld device 18. Rather, it detects user commands through motion sensing. For example, a user may hold the handheld device 18 and make a motion such as a twist, a tilt, a shake, a lateral move, or other type of movement. Such motion can be detected by the handheld device 18 with or without a display screen. Or, the user may make a gesture on the screen 20 (which is a touch screen in this case) such as a swipe, a tap, multiple quick taps, a push down (or pressing down), or other type of gestures. The handheld device 18 senses the motion or the gesture, translates the motion or the gesture into a command, and passes the command to the TV 14. In an embodiment, the command is passed to the TV 14 through the STB 16. To further this embodiment, a thin client is installed on the STB 16 which enables the STB 16 to process the commands from the handheld device 18 such as changing channels, turning to a specified channel, powering on/off, and so on. The STB 16 then sends corresponding commands along with proper graphics (such as EPG or a user interface (UI)) to the TV 14.

In various embodiments, the air mouse App may provide a user with a set of predefined motion and command pairings, or the user may configure a particular motion for a particular command based on user preferences. The following motion and command pairings are non-limiting examples that the air mouse App may include or provide.

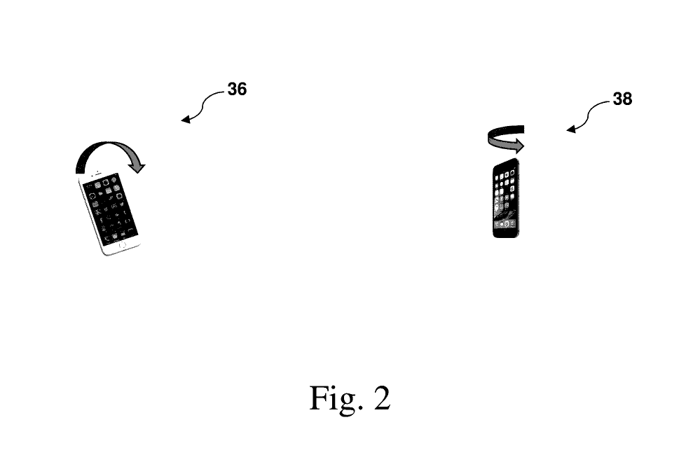

(1) Command: Change a channel
Motion: Tilt the top end of the handheld device 18 up or down relatively to the bottom end of the handheld device 18 for moving channels up or down, respectively, on the TV 14. An example of this tilting motion is shown in motion 36 of FIG. 2.

(2) Command: Change volume
Motion: Twist the handheld device 18 left (or counter-clockwise) or right (or clockwise) for decreasing or increasing the volume of the TV 14, respectively. An example of this twisting motion is shown in motion 38 of FIG. 2.

(3) Command: Pause
Motion: Quickly tap the screen 20 twice to pause a TV program if the TV program is not already in a pause state, otherwise to resume the TV program.

(4) Command: Fast forward and rewind if applicable
Motion: During a TV program's pause state, while pushing down on the screen 20, twist the handheld device 18 left or right for rewinding or fast-forwarding the TV program, respectively. Twist the handheld device 18 again in the same direction to double the speed of rewinding or fast-forwarding.

(5) Command: Move an air mouse symbol
Motion: While pushing down on the screen 20, move the handheld device 18 up, down, right, or left for moving the air mouse symbol up, down, right, or left on the TV 14 respectively.

(6) Command: Mute
Motion: Quickly tap the screen 20 three times to mute the TV 14 if it is not already in mute, otherwise to unmute.

(7) Command: Swap a channel
Motion: While pushing down on the screen 20, tilt the top end of the handheld device 18 up or down for switching a channel back and forth, respectively.

(8) Command: Show menu
Motion: Swipe up or down on the screen 20 for showing or hiding a menu on the TV 14 respectively.

(9) Command: Point to the next object while the TV 14 is in menu or EPG mode
Motion: Move the handheld device 18 up, down, left, or right to point to (or highlight) the next object that is up, down, left, or right of the current object, respectively.

In an embodiment, the handheld device 18 keeps a mapping between the TV 14's display screen and the handheld device 18's screen 20 (a touch screen or a virtual screen as discussed above). If the TV 14's screen resolution and the screen 20's resolution are different, a linear mapping between the two is used for both the X and the Y axes. A symbol of the air mouse may be displayed on the TV 14. The air mouse's position on the handheld device 18 and the air mouse symbol's position on the TV 14 are synchronized and may be updated periodically, for example, every one second. The air mouse's position on the handheld device 18 (and hence its position on the TV 14) is determined by the handheld device 18 based on motion sensing and the screen mapping above. The position of the air mouse is passed directly to the TV 14, or indirectly to the TV 14 through the STB 16. This is different from existing TV remote controls or existing air mouse (“existing devices”). The existing devices only determine a movement of the mouse, such as up, down, left, or right; but not the position of the mouse on the TV. The movement of the mouse is communicated to a STB (or a smart-TV having STB functions built in), which then determines the position of the mouse symbol on the TV. In contrast, the disclosed handheld device 18 and the air mouse App determine both the movement and the position of the mouse, which advantageously simplifies the implementation of the STB 16.

In an embodiment, the air mouse App enables other applications running on the handheld device 18 to be displayed on the TV 14. The user interfaces (UI) of these other applications are designed or developed for the screen 20, and are mapped to the TV 14's screen through the air mouse App. This enables these other applications to be developed independent of the resolution of the TV 14.

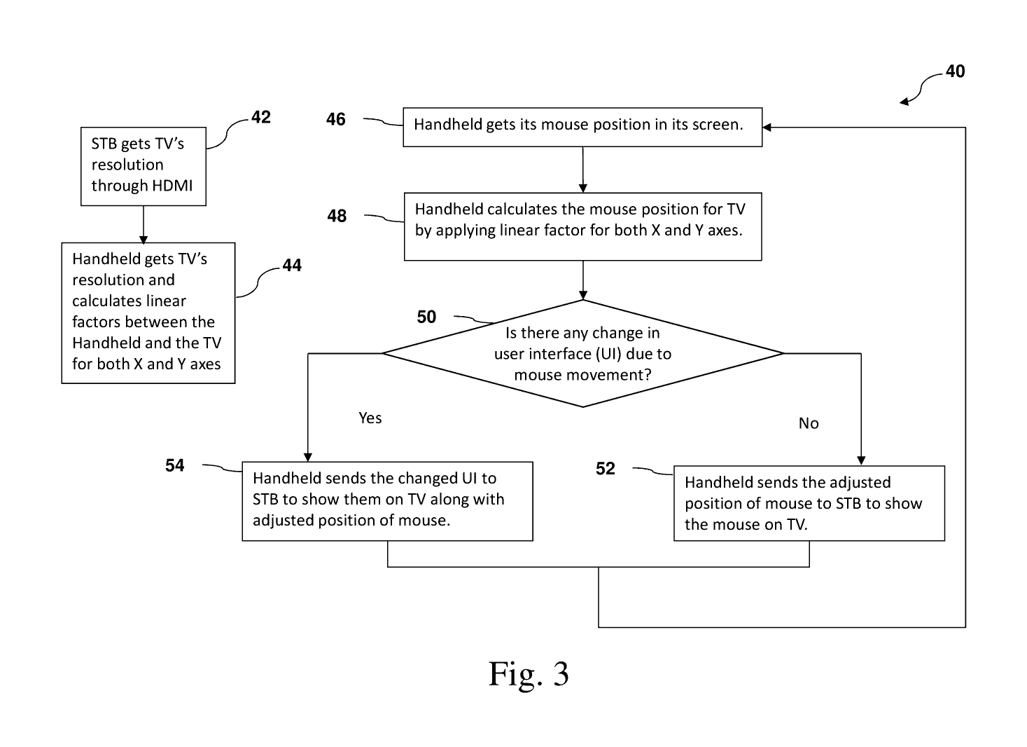

FIG. 3 shows a flow chart of a method 40 for implementing various functions for the above air mouse App. The method 40 is merely an example, and is not intended to limit the present disclosure beyond what is explicitly recited in the claims. Additional operations can be provided before, during, and after the method 40, and some operations described can be replaced, eliminated, or moved around for additional embodiments of the method.

Referring to FIG. 3, the method 40 includes multiple steps or operations 42, 44, 46, 48, 50, 52, and 54. Some of the operations may be executed in sequence and some of the operations may be executed concurrently. At operation 42, the STB 16 acquires information about the TV 14 through the link 32. The information includes the resolution of the TV 14, such as 4K (3840×2160 pixels), 1080p (1920×1080 pixels), 720p (1280×720 pixels), or other resolutions.

At operation 44, the handheld device 18 acquires some of the TV 14's information, including the resolution of the TV 14, from the STB 16 through the link 26. At operation 44, the handheld device 18 further calculates a linear mapping factor M between the TV 14's resolution and the screen 20's resolution. When running various applications (such as the air mouse App above), the handheld device 18 uses the linear mapping factor M to map its user interface (graphics or mouse position) to the TV 14's display screen.

The linear mapping factor M includes a linear factor, mₓ, for the X axis, and another linear factor, m_{y}, for the Y axis. Therefore, it may be denoted as M=(mₓ, m_{y}). In an embodiment, the linear mapping factor M is calculated by dividing the TV 14's resolution with the screen 20's resolution for the X axis and the Y axis respectively. For example, if the TV 14 and the screen 20 have the same resolution (e.g., both are 1080p), then the linear mapping factor M is (1, 1). If the TV 14's resolution is 4K and the screen 20's resolution is 1080p, then the linear mapping factor for the X axis is mₓ=3840/1920=2, and the linear mapping factor for the Y axis is m_{y}=2160/1080=2. Therefore, the linear mapping factor M is (2, 2). Various other methods of calculating the linear mapping factor M are possible. When running an application, the handheld device 18 may multiply an object's coordinates in the screen 20 by the linear mapping factor M to get the object's coordinates on the TV 14, which is subsequently sent to the TV 14 through the STB 16.

At operation 46, while running the air mouse App discussed above, the handheld device 18 gets its mouse position in the screen 20. In an embodiment, the mouse position may be initially set to the upper left corner of the screen 20. Alternatively, the initial mouse position may be set to lower right corner or another point of the screen 20. The mouse position is subsequently updated according to the methods discussed in the present disclosure, such as sensing a user's motions or recognizing a user's voice commands which is discussed below. At operation 48, the handheld device 18 calculates the corresponding air mouse's position in the TV 14's display screen by applying the linear mapping factor M as discussed above.

At operation 50, the handheld device 18 checks if there is any change in UI due to a movement of the mouse. If there is no change, at operation 52, the handheld device 18 sends the adjusted mouse position to the STB 16 which subsequently sends it to the TV 14 for displaying. If there is some change in UI, at operation 54, the handheld device 18 sends the changed UI and the adjusted mouse position to the STB 16, which subsequently sends them to the TV 14 for proper displaying. The above operations 46-54 repeat for as long as there is any movement of the air mouse, which is detected by the handheld device 18 through motion sensing or voice recognition as discussed below.

In an embodiment, the air mouse App is capable of processing voice commands. A user may make a voice command, such as “channel up,” “channel down”, “mute,” and so on. The air mouse App receives the voice command, translates the voice command to a TV command, and sends the TV command to the TV 14. In the present embodiment, the TV command is passed to the TV 14 through the STB 16. To further this embodiment, the handheld device 18 and the operating system running thereon have voice recognition capability, such as Siri of Apple Inc.'s iOS.

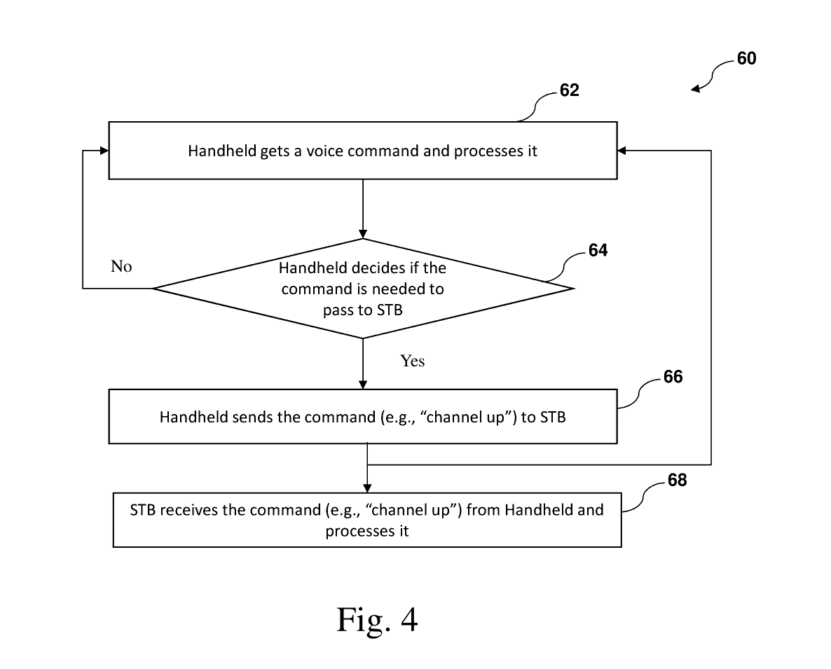

FIG. 4 shows a flow chart of a method 60 for implementing voice commands for the above air mouse App. The method 60 is merely an example, and is not intended to limit the present disclosure beyond what is explicitly recited in the claims. Referring to FIG. 4, the method 60 includes operations 62, 64, and 66. At the operation 62, the handheld device 18 gets a voice command through a tool such as Siri of Apple Inc.'s iOS. The handheld device 18 then processes the voice command. At the operation 64, the handheld device 18 decides if the voice command is needed to pass to the STB 16. In one example, the handheld device 18 compares the voice command with a set of predefined TV commands, such as “channel up,” “channel down,” “mute,” etc. If the voice command matches one of the predefined TV commands, at operation 66, the handheld device 18 sends the voice command (in proper format for the STB 16) to the STB 16. At operation 68, the STB 16 receives the command from the handheld device 18, processes it, and passes proper commands or graphics to the TV 14.

With the air mouse App running, the user does not have to look at the screen 20 of the handheld device 18. The user only needs to look at the TV 14 and issues commands through motion, gesture, or voice, as discussed above. This provides advantages over existing remote controls or mouse applications that require a user to press buttons or keys on a device. The disclosed air mouse App greatly enhances the user's viewing experiences when watching TV. For example, when a user watches TV in a dark room, he or she may not be able to see, or simply does not want to get distracted with, the buttons on a remote control. With the disclosed air mouse App, the user simply leans back and controls the TV 14 through the handheld device 18 while looking at the TV 14.

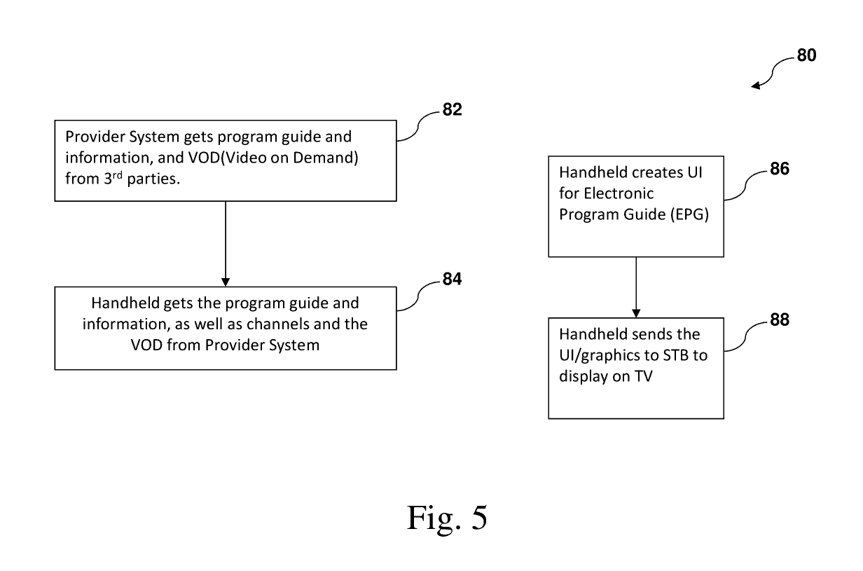

In another embodiment, the handheld device 18 is configured to run an EPG application (App) thereon, which provides an EPG function to a user. FIG. 5 shows a flow chart of a method 80 for implementing EPG App in the handheld device 18. The method 80 is merely an example, and is not intended to limit the present disclosure beyond what is explicitly recited in the claims. The following description is made with reference to FIGS. 1A and 5 collectively.

At operation 82, the TV service provider system 12 gets program guide and related information such as commentary, as well as video on Demand (VOD), from third parties. The TV service provider system 12 may compile an EPG and broadcast it to its subscribers. At operation 84, the handheld device 18 retrieves or otherwise gets the EPG from the TV service provider system 12 through the link 34, and stores the EPG in the handheld device 18 (e.g., in the internal memory 29 of the handheld device 18). The EPG may include channel lineup, VOD, commentary, etc. The EPG is updated periodically from a cloud server based on the location of the handheld device 18. At operation 86, the handheld device 18 creates a user interface (UI) of the EPG. In an embodiment, the UI of the EPG is further adjusted based on a linear mapping between the resolution of the user's TV (e.g., the TV 14) and the resolution of the screen 20. For example, the linear mapping may be the same as discussed with respect to FIG. 3. Furthermore, the adjustment is dynamically processed in real time. For example, a user may operate different TVs with the handheld device 18, such as a TV in one room and another TV in another room. The different TVs may have different resolutions. The handheld device 18 obtains the resolution of the TV that it is paired with, creates the linear mapping, and adjusts the UI of the EPG for proper display for that TV. This makes the EPG App portable from one TV to another TV. At operation 88, the handheld device 18 sends the UI of the EPG, along with any associated graphics, to the STB 16. The STB 16 subsequently sends the UI and any graphics to the TV 14 for display.

With the EPG App, the handheld device 18 becomes a personalized portable EPG for the user. Any action to the EPG by the user is processed by the handheld device 18 and the corresponding UI changes can be displayed on a TV at home or at some other locations (e.g., in a hotel room). A user may use the air mouse App above to navigate and select highlighted item(s) on the EPG.

The disclosed EPG App provides advantages over existing TV systems where an STB gets the EPG and stores it in the STB. With existing TV systems, the EPG is stored locally at home and is not portable. A user may make changes in the STB's EPG. But the changed EPG is stored in the STB at home. When the user travels away from home, he or she cannot carry the STB and hence has no access to his or her personal EPG. With the disclosed EPG App, a user has a portable personalized EPG stored conveniently in his or her handheld device. Further, the EPG App can be configured to obtain (using push-down, pull-into, or other techniques) the latest EPG from the TV service provider system 12 based on the location of the handheld device 18 which may have one or more positioning sensors (e.g., GPS receiver) in an embodiment. In some cases, TV programs differ in different locations and in different time zones. For example, the TV channels in a hotel may be a subset of available channels at home. When a user stays in the hotel and uses his or her handheld device to navigate the TV channels therein, the user's EPG in the handheld device is automatically updated for that location and only available TV channels will be displayed. This greatly enhances the user's experiences.

The disclosed EPG App provides other advantages. With the EPG App, the handheld device 18 can offload much work traditionally performed by the STB 16. The handheld device 18 can obtain the EPG and display the EPG on the TV 14. It may also display the EPG on its screen 20. In an embodiment, the handheld device 18 may run the air mouse App and the EPG App concurrently. The EPG App causes the TV 14 to display the EPG and the air mouse App allows the user to navigate, highlight, and select channels in the EPG by looking at the TV 14. This allows the design of the STB 16 to be simplified. For example, the STB 16 only needs to perform decoding and decryption for Content Access (CA) or Digital Right Management (DRM). If CA or DRM is not involved, the audio/video streaming can be directly performed by the handheld device 18 running the disclosed air mouse App and certain other applications. This allows new contents to be developed without changing existing STB.

The foregoing has outlined features of several embodiments. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A handheld device comprising a motion sensor, a graphics processor, and a wireless connectivity module, wherein the handheld device is configured to:
detect a motion of the handheld device;
translate the motion to a TV command; and
transmit the TV command using the wireless connectivity module.

2. The handheld device of claim 1, wherein the motion comprises:
a tilting of the handheld device up;
a tilting of the handheld device down;
a clockwise twisting of the handheld device;
a counter-clockwise twisting of the handheld device;
a moving of the handheld device up;
a moving of the handheld device down;
a moving of the handheld device to its left; or
a moving of the handheld device to its right.

3. The handheld device of claim 1, wherein the TV command comprises:
change a TV channel;
change a volume of a TV;
pause a TV program;
resume a TV program;
fast-forward a TV program;
rewind a TV program;
swap a TV channel;
show a menu on a TV;
hide a menu on a TV;
mute a TV; or
unmute a TV.

4. The handheld device of claim 1, wherein the TV command is transmitted to a display device through a set-top box (STB).

5. The handheld device of claim 1, further comprising a touch screen, wherein the handheld device is further configured to:
detect a gesture on the touch screen;
translate the gesture to another TV command; and
transmit the another TV command using the wireless connectivity module.

6. The handheld device of claim 5, wherein the gesture comprises:
a swiping up on the touch screen; or
a swiping down on the touch screen.

7. The handheld device of claim 1, further comprising a touch screen, wherein the handheld device is further configured to:
obtain a first resolution of a display device; and
calculate a linear mapping factor between the first resolution and a resolution of the touch screen.

8. The handheld device of claim 7, wherein the handheld device is further configured to:
obtain a mouse position in the touch screen;
calculate a corresponding mouse position for the display device using the linear mapping factor; and
transmit the corresponding mouse position using the wireless connectivity module.

9. The handheld device of claim 8, wherein the handheld device is further configured to:
detect a change in user interface on the touch screen;
calculate a corresponding change in user interface on the display device using the linear mapping factor; and
transmit the corresponding change in user interface using the wireless connectivity module.

10. The handheld device of claim 1, further comprising a voice recognition and processing unit, wherein the handheld device is further configured to:
detect another TV command through voice;
on the condition that the another TV command matches one of a set of commands, transmit the another TV command using the wireless connectivity module.

11. The handheld device of claim 1, wherein the handheld device is further configured to:
obtain an electronic program guide (EPG); and
store the EPG in the handheld device.

12. The handheld device of claim 11, wherein the handheld device is further configured to:
create a user interface for the EPG; and
transmit the user interface using the wireless connectivity module.

13. The handheld device of claim 12, wherein the handheld device is further configured to:
obtain a first resolution of a display device;
calculate a linear mapping factor between the first resolution and a resolution of the handheld device; and
adjust the user interface based on the linear mapping factor.

14. The handheld device of claim 11, wherein the handheld device is further configured to:
update the EPG based on a location of the handheld device.

15. A method of controlling a TV using a handheld device, the handheld device being capable of sensing motions, communicating wirelessly, and processing graphics, the method comprising:
detecting a motion of the handheld device;
translating the motion to a command for the TV; and
transmitting the command to the TV wirelessly.

16. The method of claim 15, wherein the transmitting of the command comprises:
transmitting the command to a set-top box (STB) wirelessly, wherein the STB sends the command to the TV.

17. The method of claim 15, further comprising:
obtaining a first resolution of the TV; and
calculating a linear mapping factor between the first resolution and a resolution of the handheld device.

18. The method of claim 17, further comprising:
obtaining a mouse position in a screen of the handheld device;
calculating a corresponding mouse position for the TV using the linear mapping factor; and
transmitting the corresponding mouse position to the TV wirelessly.

19. The method of claim 17, further comprising:
detecting a change in user interface on a screen of the handheld device;
calculating a corresponding change in user interface on the TV using the linear mapping factor; and
transmitting the corresponding change in user interface to the TV wirelessly.

20. The method of claim 17, further comprising:
obtaining an electronic program guide (EPG);
creating a user interface of the EPG for the TV; and
transmitting the user interface to the TV wirelessly.

21. A handheld device comprising a motion sensor, a graphics processor, a wireless connectivity module, a memory, and a set of instructions stored in the memory, wherein the set of instructions, once executed, cause the handheld device to:
create a command destined to a TV in response to a motion of the handheld device; and
transmit the command using the wireless connectivity module.

22. The handheld device of claim 21, wherein the set of instructions, once executed, cause the handheld device further to:
obtain a first resolution of the TV; and
calculate a linear mapping factor between the first resolution and a resolution of the handheld device.

23. The handheld device of claim 22, wherein the set of instructions, once executed, cause the handheld device further to:
obtain an electronic program guide (EPG);
store the EPG in the memory;
create a user interface of the EPG for the TV using the linear mapping factor; and
transmit the user interface of the EPG to the TV.

24. The handheld device of claim 22, wherein the set of instructions, once executed, cause the handheld device further to:
obtain a mouse position in a screen of the handheld device;
calculate a corresponding mouse position for the TV using the linear mapping factor; and
transmit the corresponding mouse position to the TV.
